(19) United States
(12) Patent Application Publication
(10) Pub. No.: US 2026/0180934 A1
(43) Pub. Date: Jun. 25, 2026

(54) METHOD, COMPUTER DEVICE, AND NON-TRANSITORY COMPUTER-READABLE RECORDING MEDIUM TO RECOMMEND AI MESSAGE BASED ON CONVERSATION CONTENT

(71) Applicant: LINE Plus Corporation, Seongnam-si (KR)

(72) Inventors: Heesu KYUNG, Seongnam-si (KR); Jisu LEE, Seongnam-si (KR); Hyun Ju JO, Seongnam-si (KR); Hunkwang HA, Seongnam-si (KR)

(73) Assignee: LINE Plus Corporation, Seongnam-si (KR)

(21) Appl. No.: 19/413,600

(22) Filed: Dec. 9, 2025

(30) Foreign Application Priority Data
Dec. 19, 2024 (KR) 10-2024-0191784

(51) Int. Cl. H04L 51/04; H04L 51/02

(52) U.S. Cl. CPC H04L 51/04; H04L 51/02

(57) ABSTRACT

Some example embodiments are directed a method, a computer device, and a non-transitory computer-readable recording medium for recommending an artificial intelligence (AI) message based on conversation content. A message recommendation method may include receiving a message recommendation request for a chatroom, sending one or more messages included in the chatroom to a server in response to the message recommendation request, and receiving, from the server, at least one artificial intelligence (AI) message generated based on the one or more messages using AI, and displaying the at least one AI message in the chatroom.

### CROSS-REFERENCE TO RELATED APPLICATION(S)

This U.S. non-provisional application and claims the benefit of priority under 35 U.S.C. § 119 to Korean Patent Application No. 10-2024-0191784, filed Dec. 19, 2024, the entire contents of which are incorporated herein by reference in their entirety.

### BACKGROUND

Some example embodiments relate to technology for recommending a message generated through artificial intelligence (AI).

An instant messenger may refer to a general communication tool that may be or include software that allows a user to send and receive a message or data in real time and allows the user to register a contact on a messenger and to send and receive messages with a counterpart on a contact list in real time.

Due to such a messenger function, the messenger is commonly used in a mobile environment of a mobile communication terminal as well as a personal computer (PC).

The use of a social platform, such as a messenger, is relatively popular and the social platform may provide relatively diverse functions.

### SUMMARY

Some example embodiments may recommend a message that matches the intent of a user based on conversation content of the user through artificial intelligence (AI).

Some example embodiments may provide a text message, a sticker message, and a multi-message in which text and a sticker are combined as a recommended message.

Some example embodiments may classify and thereby provide a recommended message within a chatroom based on a message type or category.

Some example embodiments may set a recommended message style using a prompt or a filter provided by a user.

The method and the computer device implementing the method according to some example embodiments improves user communication by recommending a message that matches the intent of a user based on conversation content of the user through artificial intelligence (AI). The method and the computer device implementing the method also classifies the recommended message based on message type or category making it relatively easier for the user to select a desired message for using in the chatroom. The method and the computer device implementing the method thus improves speed of user communication and improves communication efficiency. Because the method includes sending the source message to the server and the server processes the source message and provides the AI message, the method frees up processing resources and reduces memory utilization of the user device. As a result, power consumption of the user device is reduced and battery life of the user device is improved.

According to some example embodiments, a message recommendation method implemented on a computer device may include receiving, by at least one processor of the computer device, a message recommendation request for a chatroom, sending, by the at least one processor, one or more messages included in the chatroom to a server in response to the message recommendation request, receiving, from the server and by the at least one processor, at least one artificial intelligence (AI) message, the at least one AI message being generated based on the one or more messages using AI, and displaying the at least one AI message in the chatroom.

According to some example embodiments, the receiving the message recommendation request may include receiving the message recommendation request through a user interface (UI) within the chatroom.

According to some example embodiments, the receiving the message recommendation request may include receiving the message recommendation request through a user interface (UI) linked to a message input box within the chatroom.

According to some example embodiments, the sending may include sending, to the server, one or more previous messages based on a point in time at which the message recommendation request is received.

According to some example embodiments, the sending may include sending, to the server, a message selected from the one or more messages included in the chatroom based at least one criterion.

According to some example embodiments, the displaying may include receiving the at least one AI message belonging to at least one category according to the one or more messages.

According to some example embodiments, the displaying may include receiving the at least one AI message including a cue for a plurality of categories from the server.

According to some example embodiments, the message recommendation method may further include classifying the at least one AI message by category, and displaying the at least one AI message based on the category.

According to some example embodiments, the message recommendation method may further include displaying may include classifying and thereby displaying the AI message by message type.

According to some example embodiments, the displaying may include classifying the at least one AI message by message type, and displaying the at least one AI message based on the message type.

According to some example embodiments, the message recommendation method may further include receiving, by the at least one processor, a setting for a message style through the chatroom, receiving, from the server and by the at least one processor, the at least one AI message regenerated based on the message style using the AI, and displaying the at least one AI message regenerated based on the message style in the chatroom.

According to some example embodiments, the receiving the setting for the message style may include receiving a style example that is input through the chatroom.

According to some example embodiments, a non-transitory computer-readable recording medium stores an instruction to execute the message recommendation method on the computer device.

According to some example embodiments, a computer device includes at least one processor configured to execute a computer-readable instruction. The at least one processor configures the computer device to receive a message recommendation request for a chatroom, send one or more messages included in the chatroom to a server in response to the message recommendation request, receive, from the server, at least one artificial intelligence (AI) message generated based on the one or more messages, the at least one AI message being generated using AI, and display the at least one AI message in the chatroom.

### BRIEF DESCRIPTION OF DRAWINGS

FIG. 1 is a diagram illustrating an example of a network environment, according to some example embodiments.

FIG. 2 is a block diagram illustrating an example of a computer device, according to some example embodiments.

FIG. 3 is a flowchart illustrating an example of a method performed by a computer device, according to some example embodiments.

FIGS. 4, 5A, 5B, 6A, 6B, 7A, and 7B illustrate examples of recommending an artificial intelligence (AI) text message, according to some example embodiments.

FIGS. 8A, 8B, 9A, 9B, 10A, and 10B illustrate examples of setting a style of an AI text message, according to some example embodiments.

FIGS. 11A, 11B, 12A, and 12B illustrate examples of recommending an AI sticker message, some example embodiments.

FIGS. 13A, 13B, 14A, and 14B illustrate examples of setting a style of an AI sticker message according to some example embodiments.

### DETAILED DESCRIPTION OF EXAMPLE EMBODIMENTS

Some example embodiments will be described in detail with reference to the accompanying drawings. Example embodiments, however, may be embodied in various different forms, and should not be construed as being limited to only the illustrated embodiments. Rather, the illustrated embodiments are provided as examples so that this disclosure will be thorough and complete, and will fully convey the concepts of this disclosure to those skilled in the art. Accordingly, known processes, elements, and techniques, may not be described with respect to some example embodiments. Unless otherwise noted, like reference characters denote like elements throughout the attached drawings and written description, and thus descriptions will not be repeated.

As used herein, the singular forms “a,” “an,” and “the,” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups, thereof. As used herein, the term “and/or” includes any and all combinations of one or more of the associated listed products. Expressions such as “at least one of,” when preceding a list of elements, modify the entire list of elements and do not modify the individual elements of the list. Also, the term “exemplary” is intended to refer to an example or illustration.

Unless otherwise defined, all terms (including technical and scientific terms) used herein have the same meaning as commonly understood by one of ordinary skill in the art to which example embodiments belong. Terms, such as those defined in commonly used dictionaries, should be interpreted as having a meaning that is consistent with their meaning in the context of the relevant art and/or this disclosure, and should not be interpreted in an idealized or overly formal sense unless expressly so defined herein.

As described herein, when an operation is described to be performed, or an effect such as a structure is described to be established “by” or “through” performing additional operations, it will be understood that the operation may be performed and/or the effect/structure may be established “based on” the additional operations, which may include performing said additional operations alone or in combination with other further additional operations.

Software may include a computer program, program code, instructions, or some combination thereof, for independently or collectively instructing or configuring a hardware device to operate as desired. The computer program and/or program code may include program or computer-readable instructions, software components, software modules, data files, data structures, and/or the like, capable of being implemented by one or more hardware devices, such as one or more of the hardware devices mentioned above. Examples of program code include both machine code produced by a compiler and higher level program code that is executed using an interpreter.

A hardware device, such as a computer processing device, may run an operating system (OS) and one or more software applications that run on the OS. The computer processing device also may access, store, manipulate, process, and create data in response to execution of the software. For simplicity, one or more example embodiments may be exemplified as one computer processing device; however, one skilled in the art will appreciate that a hardware device may include multiple processing elements and multiple types of processing elements. For example, a hardware device may include multiple processors or a processor and a controller. In addition, other processing configurations are possible, such as parallel processors.

Hereinafter, some example embodiments will be described with reference to the accompanying drawings.

The example embodiments relate to technology for recommending or otherwise suggesting a message generated through artificial intelligence (AI).

Some example embodiments disclosed herein may recommend a reply message that a user may utilize, based on at least some conversation content at a point in time of request when the user requests a message recommendation in a chatroom, in terms of recommending a message generated through AI.

A message recommendation device according to some example embodiments may be implemented by at least one computer device, and a message recommendation method according to some example embodiments may be performed through at least one computer device included in the message recommendation device. Here, a computer program, according to some example embodiments, may be installed and run or executed on the computer device, and the computer device may be configured to perform the message recommendation method according to some example embodiments under control of the computer program. The aforementioned computer program may be stored in a computer-readable record medium to implement the message recommendation method in conjunction with the computer device.

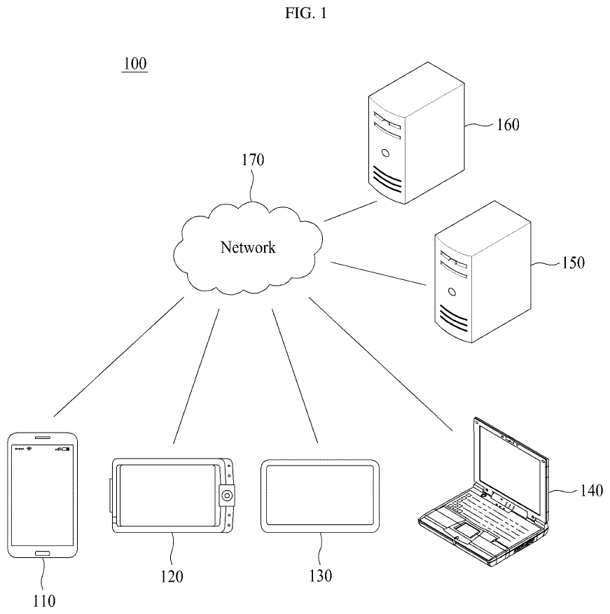

FIG. 1 illustrates an example of a network environment according to some example embodiments. Referring to FIG. 1, the network environment may include a plurality of electronic devices 110, 120, 130, and 140, a plurality of servers 150 and 160, and a network 170. FIG. 1 is provided as an example only. The number of electronic devices or the number of servers is not limited thereto. Also, the network environment of FIG. 1 is provided as one example of environments applicable to the example embodiments and an environment applicable to the example embodiments is not limited to the network environment of FIG. 1.

Each of the plurality of electronic devices 110, 120, 130, and 140 may be a fixed terminal or a mobile terminal that is configured as a computer device or a computing device. For example, the plurality of electronic devices 110, 120, 130, and 140 may be a smartphone, a mobile phone, a navigation device, a computer, a laptop computer, a digital broadcasting terminal, a personal digital assistant (PDA), a portable multimedia player (PMP), a tablet PC, and the like. For example, although FIG. 1 illustrates a shape of a smartphone as an example of the electronic device 110, the electronic device 110 used herein may refer to one of various types of physical computer devices capable of communicating with other electronic devices 120, 130, and 140, and/or the servers 150 and 160 over the network 170 in a wireless or wired communication manner.

The communication scheme is not limited, and may include a near field wireless communication scheme between devices as well as a communication scheme using a communication network (e.g., a mobile communication network, wired Internet, wireless Internet, and a broadcasting network) includable in the network 170. For example, the network 170 may include at least one of network topologies that include a personal area network (PAN), a local area network (LAN), a campus area network (CAN), a metropolitan area network (MAN), a wide area network (WAN), a broadband network (BBN), and the Internet. Also, the network 170 may include at least one of network topologies that include a bus network, a star network, a ring network, a mesh network, a star-bus network, a tree or hierarchical network, and the like. However, the network topologies are provided as examples only.

Each of the servers 150 and 160 may be configured as a computer device or a plurality of computer devices that provides an instruction, a code, a file, content, a service, etc., through communication with the plurality of electronic devices 110, 120, 130, and 140 over the network 170. For example, the server 150 may be a system that provides a service (e.g., messenger service) to the plurality of electronic devices 110, 120, 130, and 140 connected over the network 170.

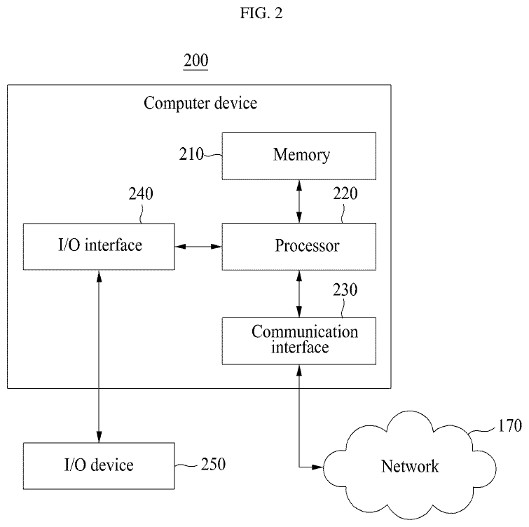

FIG. 2 is a block diagram illustrating an example of a computer device 200 according to some example embodiments. One or more of the plurality of electronic devices 110, 120, 130, and 140 or one or more of the servers 150 and 160 may be implemented by a computer device 200 of FIG. 2.

Referring to FIG. 2, the computer device 200 may include a memory 210, a processor 220, a communication interface 230, and an input/output (I/O) interface 240. The memory 210 may include a storage device, such as a random access memory (RAM), a read only memory (ROM), and a disk drive, as a non-transitory computer-readable recording medium. Another storage device, such as ROM and a disk drive, may be included in the computer device 200 as a storage device separate from the memory 210. Also, an operating system (OS) and at least one program code may be stored in the memory 210. Such software components may be loaded to the memory 210 from another non-transitory computer-readable record medium separate from the memory 210. The other non-transitory computer-readable record medium may include a non-transitory computer-readable record medium, for example, a floppy drive, a disk, a tape, a DVD/CD-ROM drive, a memory card, etc. According to some example embodiments, software components may be loaded to the memory 210 through the communication interface 230, instead of the non-transitory computer-readable record medium. For example, the software components may be loaded to the memory 210 of the computer device 200 based on a computer program installed by files received over the network 170.

The processor 220 may be configured to process instructions of a computer program by performing basic arithmetic operations, logic operations, and I/O operations. The computer-readable instructions may be provided by the memory 210 or the communication interface 230 to the processor 220. For example, the processor 220 may be configured to execute received instructions in response to a program code stored in a storage device, such as the memory 210.

The communication interface 230 may provide a function or may be configured for communication between the computer device 200 and another apparatus, for example, the aforementioned storage devices, over the network 170. For example, the processor 220 of the computer device 200 may forward a request or an instruction created based on a program code stored in the storage device such as the memory 210, data, and a file, to other apparatuses over the network 170 under control of the communication interface 230. Inversely, a signal, an instruction, data, a file, etc., from another apparatus may be received at the computer device 200 through the communication interface 230 of the computer device 200. A signal, an instruction, data, etc., received through the communication interface 230 may be forwarded to the processor 220 or the memory 210, and a file, etc., may be stored in a storage medium, for example, the permanent storage device, further included in the computer device 200.

The I/O interface 240 may be a device used for interfacing with an I/O device 250. For example, an input device may include a device, such as a microphone, a keyboard, a mouse, etc., and an output device may include a device, such as a display, a speaker, etc. As another example, the I/O interface 240 may be a device for interfacing with an apparatus in which an input function and an output function are integrated into a single function, such as a touchscreen. The I/O device 250 may be configured as a single apparatus with the computer device 200.

Also, according to some example embodiments, the computer device 200 may include more components than the components shown in FIG. 2 or less number of components than the number of components shown in FIG. 2. For example, the computer device 200 may be configured to include at least a portion of the I/O device 250 or may further include other components, such as a transceiver and/or a database.

Hereinafter, example embodiments of a method and device for recommending an AI message based on conversation content will be described.

Herein, the term “social platform” may represent any social platform that provides various types of services using resources, such as user profile information and friend relationships in a social network service, as well as the social network service.

The following example embodiments are described using a messenger (e.g., a chat messenger) as a representative example of a social platform.

Some example embodiments may recommend or otherwise suggest a message that matches (or suggests or conveys) the intent of a user based on the conversation content of the user through AI, when recommending a message that the user may use as a reply message in the conversation.

The computer device 200, according to some example embodiments, may provide a client with a messenger service through connection to an application (e.g., an exclusive or customized application) installed on the client or a website/mobile site related to the computer device 200. A message recommendation device implemented as a computer may be configured in the computer device 200. For example, the message recommendation device may be implemented in the form of a program that independently operates or may be configured in an in-app form of a specific or desired or given application to be operable on the specific or desired or given application.

The processor 220 of the computer device 200 may be implemented or configured as a component to perform the message recommendation method discussed below. In some example embodiments, components of the processor 220 may be selectively included in or excluded from the processor 220. Also, in some example embodiments, the components of the processor 220 may be separated or merged for functional representation of the processor 220.

The processor 220 and/or the components of the processor 220 may control the computer device 200 to perform operations included in the message recommendation method discussed below. For example, the processor 220 and/or the components of the processor 220 may be configured to execute an instruction according to a code of at least one program and a code of an OS included in the memory 210.

Here, the components of the processor 220 may be representations of different functions performed by the processor 220 in response to an instruction provided from a program code stored in the computer device 200.

The processor 220 may read an instruction from the memory 210 that may store or that may be loaded with instructions related to control of the computer device 200. In some example embodiments, the read instruction may include an instruction for controlling the processor 220 to perform the operations discussed below.

Operations included in the message recommendation method may be performed in an order different from the illustrated order. Some of the operations may be omitted or an additional process may be further included.

Operations included in the message recommendation method may be performed by the client. In some example embodiments, one or more of the operations may be performed by the server 150. However, in some example embodiments, the operations may be performed by the server 150 and/or the server 160.

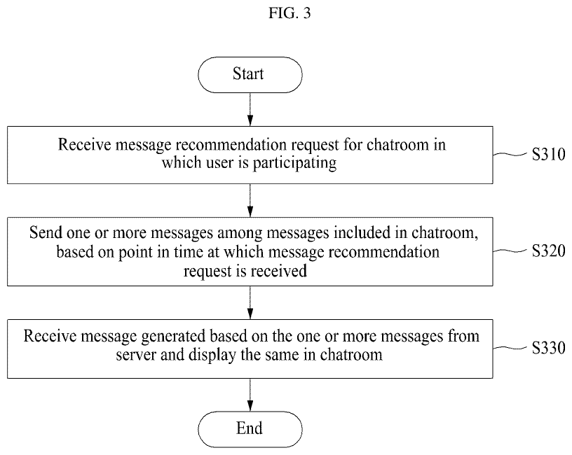

FIG. 3 is a flowchart illustrating an example of a method performed by a computer device according to some example embodiments. It is understood that additional operations can be provided before, during, and after the operations in FIG. 3, and some of the operations described below can be replaced or eliminated, for additional embodiments of the method. The order of the operations/processes may be interchangeable, or two or more operations can be performed simultaneously.

Referring to FIG. 3, in operation S310, the processor 220 may receive, from a user, a message recommendation request for a chatroom in which the user is participating. In some example embodiments, the processor 220 may receive the message recommendation request from the user through a user interface (UI) within the chatroom. For example, the processor 220 may receive the message recommendation request from the user through a UI that is predefined or programmed to request a message recommendation to a UI linked to a message input box within the chatroom, for example, a UI adjacent to the message input box.

In operation S320, in response to the message recommendation request from the user, the processor 220 may send one or more messages (hereinafter, referred as ‘source messages’) included in the chatroom to the server 150, based on a point in time at which the message recommendation request is received. The source messages may be messages sent by the user prior to the point in time at which the message recommendation request is sent by the user. For example, the processor 220 may send a predetermined or desired or given number (e.g., 15) of source messages among previous conversation messages to the server 150 occurring (or communicated) before the point in time at which the message recommendation request is received from the user. In some example embodiments, the processor 220 may select at least one source message to be sent to the server 150 from among previous conversation messages through filtering according to a predetermined or desired or given criterion. For example, the processor 220 may select and send a text type message of a predetermined or desired or given number of characters to the server 150, excluding messages such as a short message such as ‘yes,’ ‘no,’ and ‘kkk,’ or a sticker, a picture, and a video.

In operation S330, in response to the message recommendation request from the user, the processor 220 may receive a message (hereinafter, referred to as ‘AI message’) that may be generated based on the source message through or using AI from the server 150 and may display the same in the chatroom.

The server 150 may generate and provide an AI message that matches (or suggests or conveys) the intent of the user based on the source message according to the message recommendation request through AI. The AI message may be provided in a brief style within or having a predetermined (or desired or given) length, and may be generated into at least one message type. The message type may include a text type, a sticker type, and a multi-type in which text and a sticker are combined. The server 150 may recommend an AI message that belongs to at least one category based on presence or absence of a source message and an age. For example, categories may include greetings, positives, and negatives, and cue indicating which category a corresponding message is from may be included in the AI message. For example, assuming that up to five AI messages are provided in response to the message recommendation request from the user, (1) only five AI messages in the ‘Greetings’ category may be provided when there are no source messages due to absence of messages in the chatroom, or when source messages are messages older than 7 days, (2) When source messages are not same-day messages but messages from within 7 days, three AI messages in the ‘Greetings’ category and a single AI message each in the ‘Positives’ category and ‘Negatives’ category may be provided, (3) When source messages are same-day messages, an AI message in the ‘Greetings’ category may be omitted, and three AI messages in the ‘Positives’ category and two AI messages in the ‘Negatives’ category may be provided.

When displaying AI messages received from the server 150 in response to the message recommendation request from the user, the processor 220 may classify and display the AI messages by category. In some example embodiments, AI messages within a chatroom may be displayed without categorization. In some example embodiments, the processor 220 may display an AI message by identifying a message type, for example, including text type, sticker type, or multi-type in which text and sticker are combined. The processor 220 may display AI messages in conjunction with the message input box within the chatroom, and when the user selects a single AI message from among the AI messages, the corresponding message may be input (e.g., automatically) in the message input box.

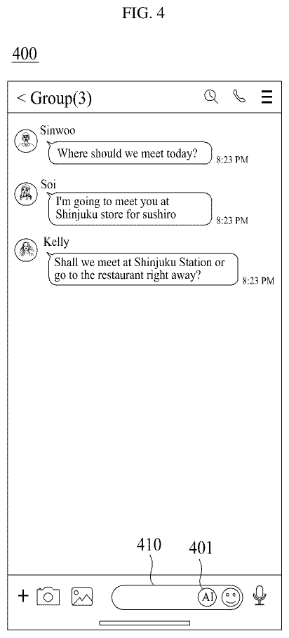

FIGS. 4, 5A, 5B, 6A, 6B, 7A, and 7B illustrate examples of recommending an AI text message, according to some example embodiments.

FIG. 4 illustrates a screen of a chatroom in which a user is participating as a messenger chatroom. The chatroom 400 may include an ‘AI’ button 401 as a UI for requesting message recommendation. The ‘AI’ button 401 may be configured within a message input box 410 of the chatroom 400 or adjacent to the message input box 410.

An AI-based message recommendation function may be configured to be turned on/off for each chatroom 400. If the message recommendation function is turned on through environment settings of the chatroom 400, for example, when entering the chatroom 400, the ‘AI’ button 401 may be displayed to be in an activated state.

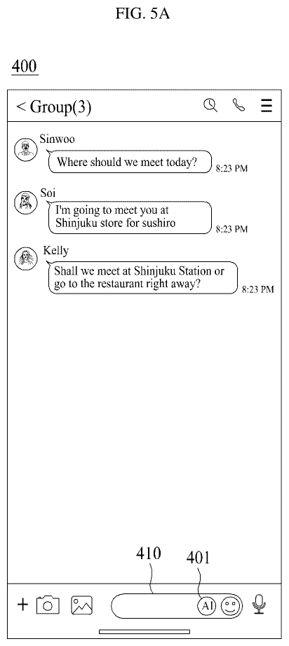

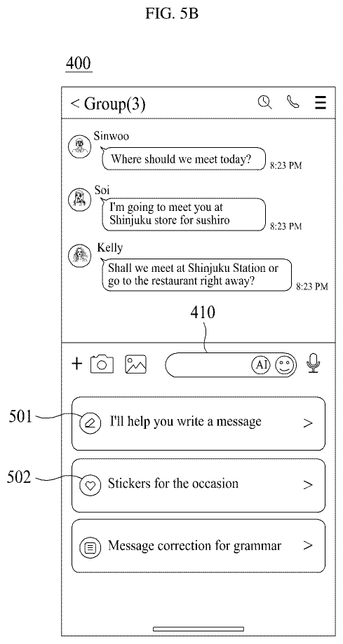

Referring to FIG. 5A, the user selects the ‘AI’ button 401 in the chatroom 400, and as illustrated in FIG. 5B, the processor 220 may provide an AI menu list related to AI messages, for example, at the bottom of (or below) the message input box 410 of the chatroom 400. In some example embodiments, the AI menu list may include a ‘message recommendation’ menu 501 for requesting AI message recommendation of a text type and a ‘sticker recommendation’ menu 502 for requesting AI message recommendation of a sticker type.

Referring to FIG. 5B, when the user selects the ‘message recommendation’ menu 501 in the chatroom 400, the processor 220 may send a predetermined (or desired or given) number of messages among messages within the chatroom 400 as source messages to the server 150 along with a message recommendation request of the user. Therefore, the server 150 may generate and provide text type AI messages through or using AI based on the source messages sent along with the message recommendation request from the user.

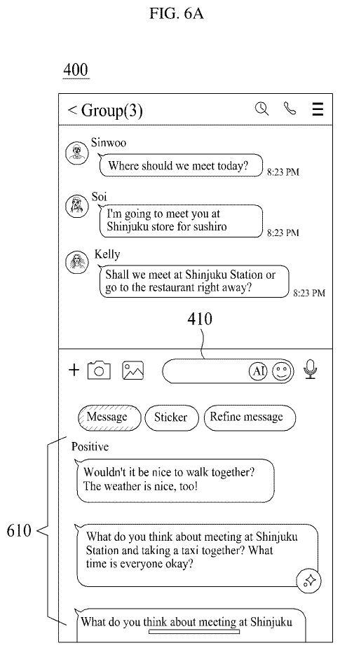

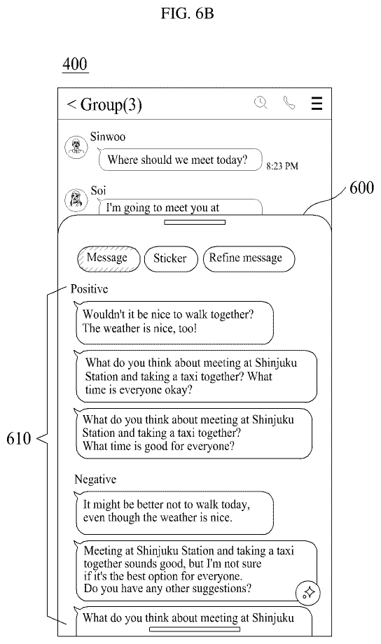

When the user selects the ‘message recommendation’ menu 501 in the chatroom 400, the processor 220 may receive AI messages 610 generated based on the source messages from the server 150, and may display the same below the message input box 410 of the chatroom 400, as illustrated in FIG. 6A.

The processor 220 may display the AI messages 610 by classifying them by category (e.g., greetings, positives, negatives). In some example embodiments, the AI messages 610 may be displayed without categorization.

When a scroll input is received from the user in order to scroll up (or down) the AI messages 610 displayed below the message input box 410 of the chatroom 400, the processor 220 may display the AI messages 610 through a separate overlay screen 600 within the chatroom 400, as illustrated in FIG. 6B.

The user may browse the AI messages 610 provided from the server 150 through the overlay screen 600 within the chatroom 400.

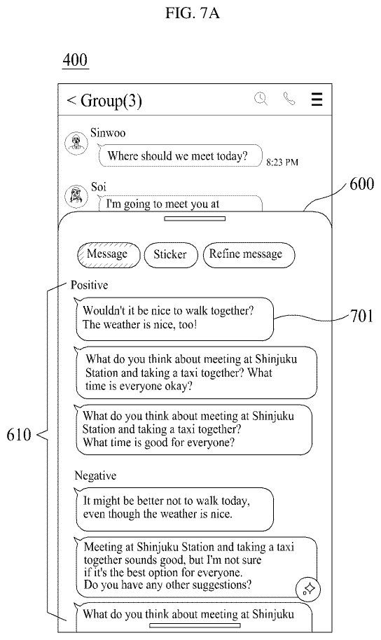

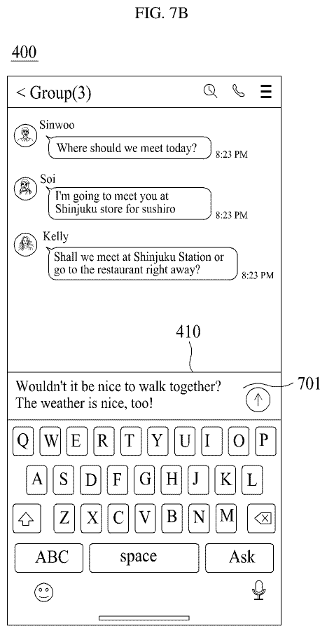

Referring to FIG. 7A, when the user selects a single message 701 from among the AI messages 610 displayed below the message input box 410 of the chatroom 400 or on the overlay screen 600, the processor 220 may input (e.g., automatically) the selected message 701 into the message input box 410, as illustrated in FIG. 7B.

The user may use the AI messages 610 without directly writing a message to be sent to the chatroom 400, and may send as is or modify and send the message 701 input (e.g., automatically) into the message input box 410 to the chatroom 400.

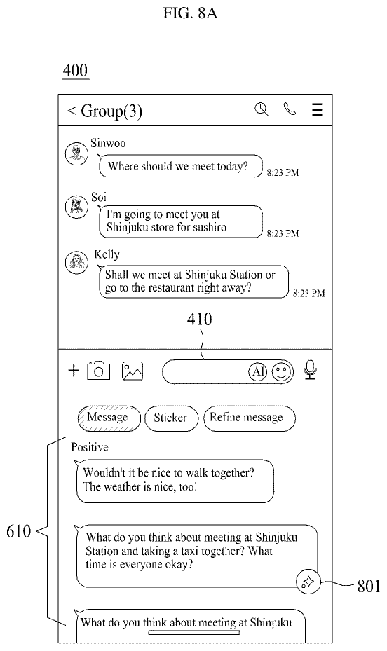

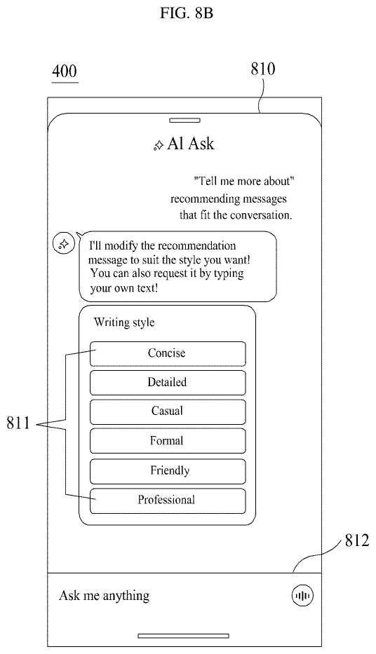

FIGS. 8A, 8B, 9A, 9B, 10A, and 10B illustrate examples of setting a style of an AI text message, according to some example embodiments.

Referring to FIG. 8A, the processor 220 may activate and display an ‘AI settings’ menu 801 for setting the style, for example, tone and manner of the AI messages 610 in connection with the AI messages 610 in the process of displaying the AI messages 610 below the message input box 410 of the chatroom 400 or on the overlay screen 600.

When the user selects the ‘AI settings’ menu 801 in the chatroom 400, as illustrated in FIG. 8B, the processor 220 may provide an AI settings screen 810 on the chatroom 400.

The AI settings screen 810 refers to an interface screen for settings of the AI messages 610, and may allow the user to directly set the style as per the preferences of the user. As illustrated in FIG. 8B, the AI settings screen 810 may include a message style list 811, the message style may include a message's length, tone, and language, and whether a sticker is used in the message, and may include, for example, concise, detailed, formal, and friendly.

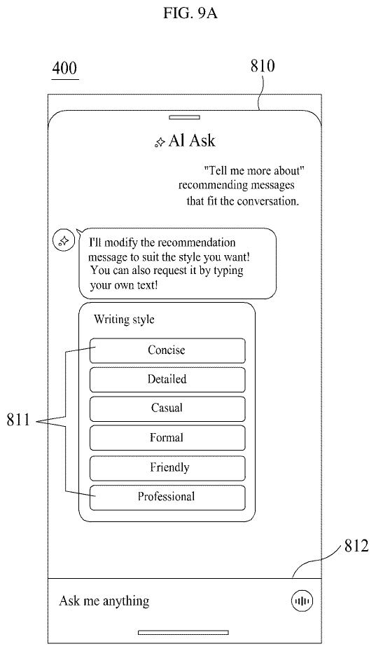

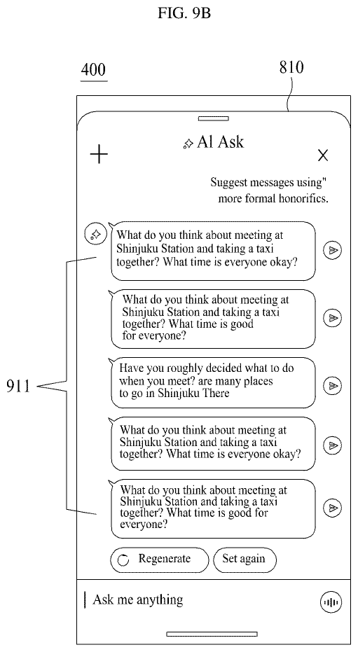

Referring to FIG. 9A, in response to a selection on a desired style on the message style list 811 of the AI settings screen 810, the processor 220 may request the server 150 to recommend a message of the corresponding style and, as illustrated in FIG. 9B, may display AI messages 911 regenerated to match the style requested by the user.

As illustrated in FIG. 9B, the AI settings screen 810 may include a prompt input box 812 that allows the user to directly enter a prompt in addition to the message style list 811.

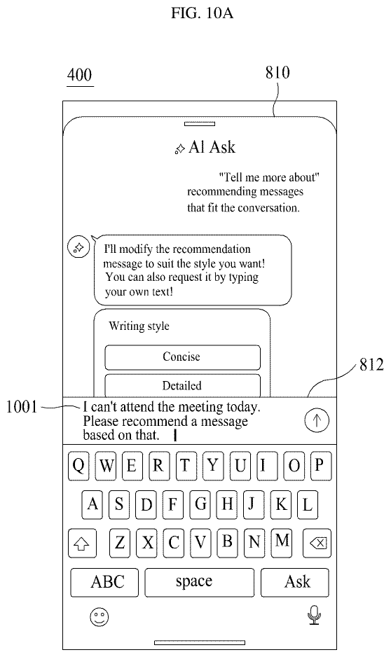

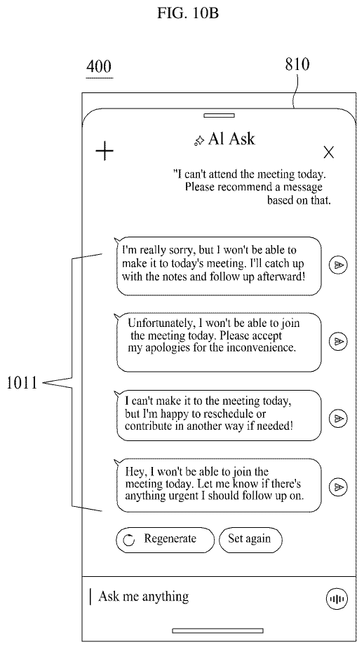

Referring to FIG. 10A, when the user enters a style example 1001 of a message desired by the user into the prompt input box 812 of the AI settings screen 810, the processor 220 may deliver the style example 1001 entered from the user to the server 150, and, as illustrated in FIG. 10B, may provide AI messages 1011 regenerated into a similar style based on the style example 1001 provided from the user as a prompt.

The regenerated AI messages 911 (FIG. 9B), 1011 (FIG. 10B) may include messages regenerated from the AI messages 610 into the style desired by the user.

When a single message is selected from among the regenerated AI messages 911, 1011 on the AI settings screen 810, the selected message may be input (e.g., automatically) to the message input box 410 of the chatroom 400.

The user may send messages to the chatroom 400 using the AI messages 911, 1011 regenerated into the style desired by the user, in addition to the AI messages 610.

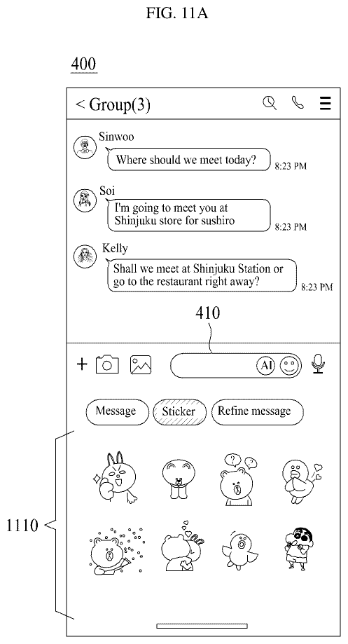

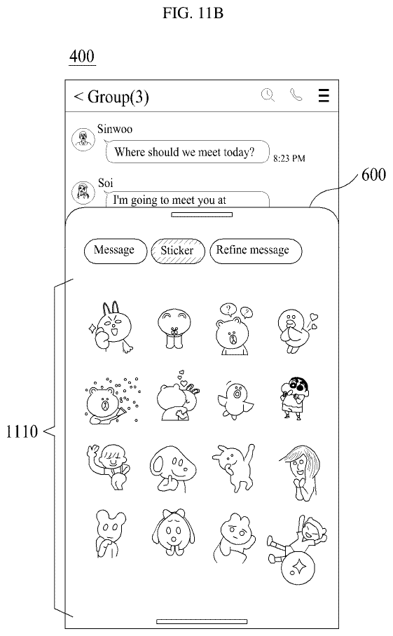

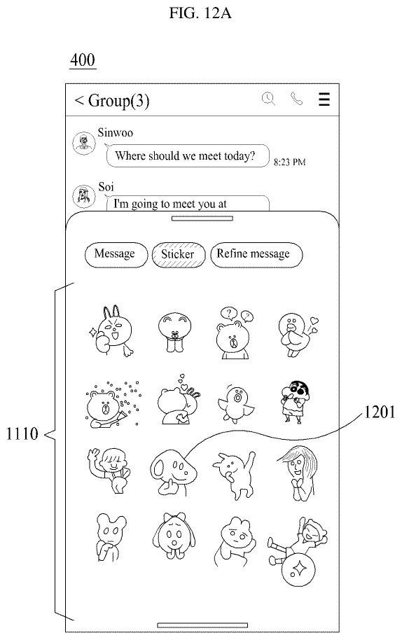

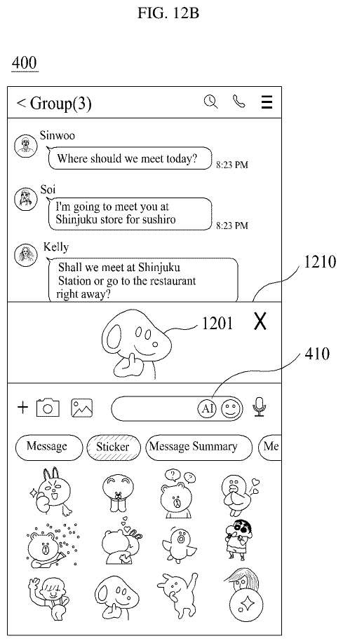

FIGS. 11A, 11B, 12A, and 12B illustrate examples of recommending an AI sticker message, according to some example embodiments.

Referring to FIG. 11A, when the user selects the ‘sticker recommendation’ menu 502 (FIG. 5B) in the chatroom 400, the processor 220 may receive AI stickers 1110 from the server 150 and may display the same below the message input box 410 of the chatroom 400.

The AI stickers 1110 may include stickers directly generated based on source messages, and may include some stickers selected from among stickers registered on a messenger platform based on the source messages.

If a scroll input is received from the user in order to scroll up (or down) the AI stickers 1110 displayed below the message input box 410 of the chatroom 400, as illustrated in FIG. 11B, the processor 220 may display the AI stickers 1110 through the separate overlay screen 600 within the chatroom 400.

The user may browse the AI stickers 1110 provided from the server 150 through the overlay screen 600 within the chatroom 400.

Referring to FIG. 12A, when the user selects a single sticker 1201 from among the AI stickers 1110 displayed below the message input box 410 of the chatroom 400 or on the separate overlay screen 600, as illustrated in FIG. 12B, the processor 220 may provide a sticker preview 1210 for the selected sticker 1201.

The user may use the AI stickers 1110 without directly selecting a sticker to be sent to the chatroom 400, and may send the sticker 1201 specified through the sticker preview 1210 to the chatroom 400.

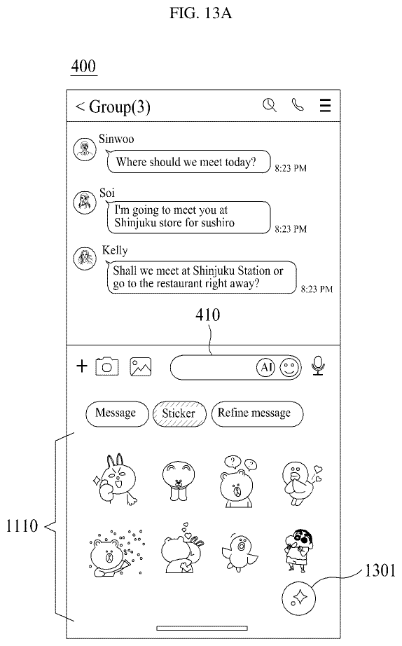

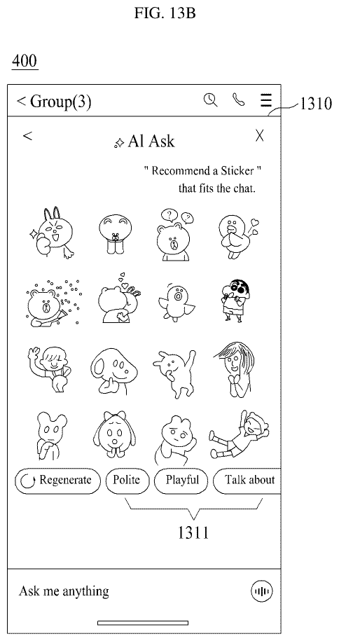

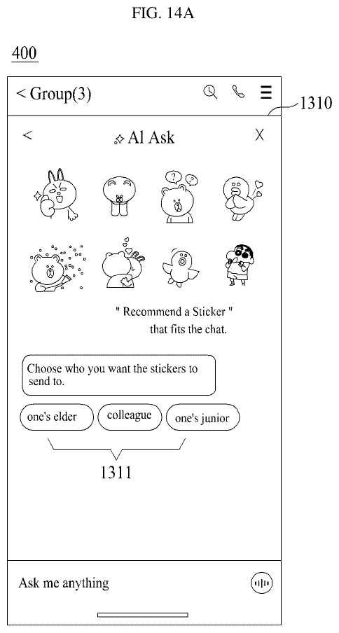

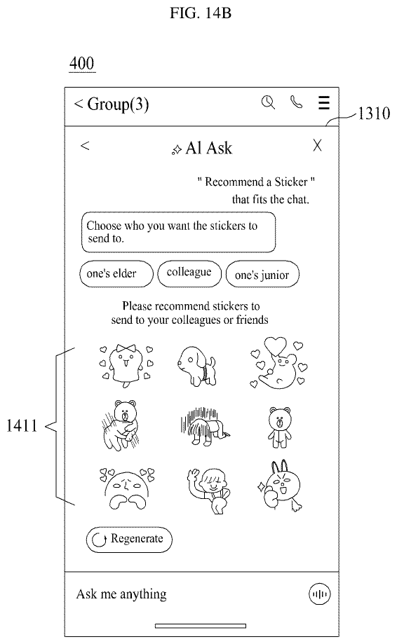

FIGS. 13A, 13B, 14A, and 14B illustrate examples of setting a style of an AI sticker message, according to some example embodiments.

Referring to FIG. 13A, the processor 220 may activate and display an ‘AI settings’ menu 1301 for setting the style of the AI stickers 1110 in conjunction with the AI stickers 1110 in the process of displaying the AI stickers 1110 below the message input box 410 of the chatroom 400 or on the overlay screen 600.

When the user selects the ‘AI settings’ menu 1301 in the chatroom 400, as illustrated in FIG. 13B, the processor 220 may provide an AI setting screen in on the chatroom 400 that may include a sticker style list 1311.

The AI setting screen 1310 refers to an interface screen for detailed settings of the AI stickers 1110, and the user may directly set a style as per the preferences of the user. As illustrated in FIGS. 13B and 14A, the sticker style may include, for example, polite, playful, one's elder, colleague, and one's junior.

Referring to FIG. 14A, in response to a selection on a desired style on the sticker style list 1311 of the AI setting screen 1310, the processor 220 may request the server 150 to recommend a sticker of the corresponding style and may display the AI stickers 1411 regenerated into the style requested by the user.

As illustrated in FIG. 14B, the user may send a sticker to the chatroom 400 using AI stickers 1411 regenerated into the style desired by the user, in addition to the AI stickers 1110.

Recommendation paths for text type AI messages and sticker type AI messages are separately described, but are not limited thereto. In some example embodiments, a common recommendation path may be applied to recommend text type AI messages and sticker type AI messages together in response to a message recommendation request of a user. When recommending text type AI messages and sticker type AI messages together, message types may be classified and thereby displayed. For example, tabs may be configured for each message type, and text type AI messages and sticker type AI messages may be displayed through the respective tabs.

According to some example embodiments, it is possible to recommend a message that matches the intent of a user based on conversation content of the user through AI, and to provide a text message, a sticker message, and a multi-message in which text and a sticker are combined as a recommended message.

According to some example embodiments, it is possible to classify and thereby provide a recommended message within a chatroom based on a message type or category, and to set a recommended message style using a prompt or a filter provided by a user.

The systems or the apparatuses described above may be implemented using hardware components, software components, and/or combination thereof. For example, the apparatuses and components described herein may be implemented using one or more general-purpose or special purpose computers, for example, a processor, a controller, an arithmetic logic unit (ALU), a digital signal processor, a microcomputer, a field programmable gate array (FPGA), a programmable logic unit (PLU), a microprocessor, or any other device capable of responding to and executing instructions in a defined manner. A processing device may run an operating system (OS) and one or more software applications that run on the OS. The processing device also may access, store, manipulate, process, and create data in response to execution of the software. For sake of discussion, the description of the processing device is used as singular; however, one skilled in the art will be appreciated that the processing device may include multiple processing elements and/or multiple types of processing elements. For example, the processing device may include multiple processors or a processor and a controller. In addition, different processing configurations are possible, such as parallel processors.

The software may include a computer program, a piece of code, an instruction, or some combinations thereof, for independently or collectively instructing or configuring the processing device to operate as desired. Software and/or data may be embodied in any type of machine, component, physical equipment, or a computer storage medium or device, to provide instructions or data to or to be interpreted by the processing device. The software also may be distributed over network coupled computer devices so that the software is stored and executed in a distributed fashion. The software and data may be stored by one or more computer readable storage mediums.

The methods according to some example embodiments may be configured in a form of program instructions performed through various computer methods and recorded in non-transitory computer-readable media. Here, the media may permanently store computer-executable programs or may temporarily store the same for execution or download. Also, the media may be or include different types of recording devices or storage devices in a form in which one or a plurality of hardware components are combined. Without being limited to media directly connected to a computer system, the media may be distributed over the network. Examples of the media may include magnetic media such as hard disks, floppy disks, and magnetic tapes; optical media such as CD-ROM and DVDs; magneto-optical media such as floptical disks; and hardware devices that are specially configured to store and perform program instructions, such as ROM, RAM, flash memory, and the like. Examples of other media may include recording media and storage media managed by an app store that distributes applications or a site, a server, and the like that supplies and distributes other various types of software.

As described herein, any devices, systems, modules, portions, units, controllers, circuits, and/or portions thereof according to any of the example embodiments, and/or any portions thereof (including, without limitation, the plurality of electronic devices 110, 120, 130, and 140, the plurality of servers 150 and 160, the network 170, the computer device 200, the memory 210, the processor 220, the communication interface 230, the input/output (I/O) interface 240, the I/O device 250, any portion thereof, or the like) may include, may be included in, and/or may be implemented by one or more instances of processing circuitry such as hardware including logic circuits; a hardware/software combination such as a processor executing software; or a combination thereof. For example, the processing circuitry more specifically may include, but is not limited to, a central processing unit (CPU), an arithmetic logic unit (ALU), a graphics processing unit (GPU), an application processor (AP), a digital signal processor (DSP), a microcomputer, a field programmable gate array (FPGA), a System-on-Chip (SoC), a programmable logic unit, a microprocessor, application-specific integrated circuit (ASIC), a neural network processing unit (NPU), an Electronic Control Unit (ECU), an Image Signal Processor (ISP), and the like. In some example embodiments, the processing circuitry may include a non-transitory computer readable storage device (e.g., a memory), for example a solid state drive (SSD), storing a program of instructions, and a processor (e.g., CPU) configured to execute the program of instructions to implement the functionality and/or methods performed by some or all of any devices, systems, modules, portions, units, controllers, circuits, and/or portions thereof according to any of the example embodiments. The processing circuitry may include electrical components such as at least one of transistors, resistors, capacitors, etc. The processing circuitry may include electrical components such as logic gates including at least one of AND gates, OR gates, NAND gates, NOT gates, etc.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

What is claimed is:

1. A message recommendation method implemented on a computer device, the message recommendation method comprising:
receiving, by at least one processor of the computer device, a message recommendation request for a chatroom;
sending, by the at least one processor, one or more messages included in the chatroom to a server in response to the message recommendation request;
receiving, from the server and by the at least one processor, at least one artificial intelligence (AI) message, the at least one AI message being generated based on the one or more messages using AI; and
displaying the at least one AI message in the chatroom.

2. The message recommendation method of claim 1, wherein the receiving the message recommendation request comprises receiving the message recommendation request through a user interface (UI) within the chatroom.

3. The message recommendation method of claim 1, wherein the receiving message recommendation request comprises receiving the message recommendation request through a user interface (UI) linked to a message input box within the chatroom.

4. The message recommendation method of claim 1, wherein the sending comprises sending, to the server, one or more previous messages based on a point in time at which the message recommendation request is received.

5. The message recommendation method of claim 1, wherein the sending comprises sending, to the server, a message selected from the one or more messages included in the chatroom based on at least one criterion.

6. The message recommendation method of claim 1, wherein the displaying comprises receiving the at least one AI message belonging to at least one category according to the one or more messages.

7. The message recommendation method of claim 1, wherein the displaying comprises receiving the at least one AI message including a cue for a plurality of categories from the server.

8. The message recommendation method of claim 1, further comprising:
classifying the at least one AI message by category; and
displaying the at least one AI message based on the category.

9. The message recommendation method of claim 1, further comprising:
classifying the at least one AI message by message type; and
displaying the at least one AI message based on the message type.

10. The message recommendation method of claim 1, wherein the displaying comprises displaying the at least one AI message in conjunction with a message input box within the chatroom.

11. The message recommendation method of claim 1, further comprising:
receiving, by the at least one processor, a setting for a message style through the chatroom;
receiving, from the server and by the at least one processor, the at least one AI message regenerated based on the message style using the AI; and
displaying the at least one AI message regenerated based on the message style in the chatroom.

12. The message recommendation method of claim 11, wherein the receiving the setting for the message style comprises receiving a style example that is input through the chatroom.

13. A non-transitory computer-readable recording medium storing an instruction to execute the message recommendation method of claim 1 on the computer device.

14. A computer device comprising:
at least one processor configured to execute a computer-readable instruction,
wherein the at least one processor configures the computer device to:
receive a message recommendation request for a chatroom;
send one or more messages included in the chatroom to a server in response to the message recommendation request;
receive, from the server, at least one artificial intelligence (AI) message generated based on the one or more messages, the at least one AI message being generated using AI; and
display the at least one AI message in the chatroom.

15. The computer device of claim 14, wherein the at least one processor configures the computer device to receive the message recommendation request through a user interface (UI) linked to a message input box within the chatroom.

16. The computer device of claim 14, wherein the at least one processor configures the computer device to send, to the server, one or more previous messages based on a point in time at which the message recommendation request is received.

17. The computer device of claim 14, wherein the at least one processor configures the computer device to send, to the server, a message selected from the one or more messages included in the chatroom based on at least one criterion.

18. The computer device of claim 14, wherein the at least one processor configures the computer device to classify the at least one AI message by category or by message type, and display the at least one AI message based on the category or the message type.

19. The computer device of claim 14, wherein the at least one processor configures the computer device to display the at least one AI message in conjunction with a message input box within the chatroom.

20. The computer device of claim 14, wherein the at least one processor configures the computer device to,
receive a setting for a message style through the chatroom;
receive, from the server, the at least one AI message regenerated based on the message style using the AI; and
display the at least one AI message regenerated based on the message style in the chatroom.
